(19) United States
(12) Patent Application Publication
(10) Pub. No.: US 2008/0016574 A1
(43) Pub. Date: Jan. 17, 2008

(54) Antivirus Method And System

(76) Inventor: Diego Angelo Tomaselli, Roma RM (IT)

Correspondence Address: NIXON & VANDERHYE, PC, 901 NORTH GLEBE ROAD, 11TH FLOOR, ARLINGTON, VA, 22203, US

(21) Appl. No.: 11/665,352

(22) PCT Filed: Oct. 17, 2005
(86) PCT No.: PCT/IB05/53402

§ 371 Date: Apr. 13, 2007

(30) Foreign Application Priority Data
Oct. 20, 2004 (IT) RM2004A000517

(51) Int. Cl. G06F 21/00

(52) U.S. Cl. 726/24

(57) ABSTRACT

A method for blocking the messages generated by computer viruses of “mail bomber” or “blackmailer” type, known to generate massive sendings of random messages aimed at damaging non-infected systems, comprises a step of determining whether the message has been originated by a known virus, a step of singling out the user (i.e., the email address) hosting on its own system the virus, a step of emulating the behaviour of the virus, so as to simulate an infected state and thereby preventing the infected system from sending a large number of random messages to the protected system.

The present invention relates to an antivirus method and system, in particular aimed at preventing the propagation of viruses of the so-called “mail bomber” or “blackmailer” type.

Computer viruses are software programs whose basic operation is that of auto-installing on a computer system and auto-propagating to other systems via network connections, or auto-sending by means of electronic mail (email) messages to all addresses found on the infected system.

Apart from these basic actions, a virus can cause other damages, such as data erasing, spamming, access into the system by unauthorized users, overloading of certain Internet sites, etc.

Hence, owing to the spreading of the first viruses, there have been created programs, just called anti-virus, preventing a system from being infected, i.e., preventing the virus from being installed on the system, or eliminating it if found already installed.

These systems analyze data present on the system to be protected (or inputted therein/outputted therefrom) and compare them to a database on which there are stored information on known viruses apt to enable their identifying inside files. When a virus is identified, the files (or the messages) containing it are blocked or diverted/rerouted or displaced, or anyhow submitted to the user's attention.

Suchlike defences are effective since the potential virus-caused damages can occur only after the virus has installed itself on the system to be protected; therefore, by preventing the virus from getting to the protected system, or eliminating the virus even after it has installed itself, the problem is solved.

However, there are specific virus types (called “mail bombers” or “blackmailers”) capable of causing serious damages (like the overloading of an electronic mailbox, hence the name “mail bomber”) even though uninstalled on the system “hit” (in practice, acting from the outside) and these damages are unavoidable, as anti-virus programs have no way to eliminate the virus, just because the latter does not reside on the system to be protected but on the outside.

The virus ceases to cause damages only when the user hit by the “mail bombing” action voluntarily decides to infect his/her system (hence the name “blackmailer”). In fact, by infecting itself, the “bombed” system will be capable of correctly communicating with the “bombing” system, the former disclosing its having been infected to the latter. Hence, the auto-infected user will be “rewarded” with the end of the “bombing” and therefore may continue to normally use his/her electronic mailbox, not overloaded anymore.

On the other hand, the installed virus will start, without the user realizing it, to overload further e-mail addresses found on his/her system, thereby starting to “blackmail” further users, until them also decide to become infected, i.e. of installing them also the virus, and so on.

It will be understood that a known anti-virus program would certainly be capable of recognizing and eliminating such a virus; yet, were it to eliminate the latter, this would cause a failed communication with the other infected systems, which therefore would restart bombing the newly cleaned system, saturating it and therefore making it useless.

The only course practicable without becoming infected would be that of automatically eliminating the messages recognized as effect of a mail bombing action; yet this is very difficult, as the messages used for the “bombing” may be different the one from the other and also burdensome in terms of data traffic, space for the temporary storage (buffering) of the messages to be analyzed and time spent for the related analysis.

Hence, object of the present invention is to solve said problems, by providing an antivirus method as defined in claim 1.

The present invention further relates to an antivirus system as defined in claim 12.

Further object of the present invention is to provide a computer program, in particular comprising one or more processor programs, apt to implement a method according to the present invention as defined in claims 1 to 11.

The main advantage of the method according to the present invention lies in that it solves the problem linked to such a virus typology in a more effective and inexpensive way, preventing the virus from carrying out its mail bombing action and concomitantly preventing the infecting of the system to be protected. In practice, this occurs by emulating the behaviour of the virus, thereby faking an infected state of the system to be protected.

Further advantages, as well as the features and the operation modes of the present invention will be made apparent in the following detailed description of some embodiments thereof, given by way of example and without limitative purposes, making reference to the figures of the annexed drawings, wherein:

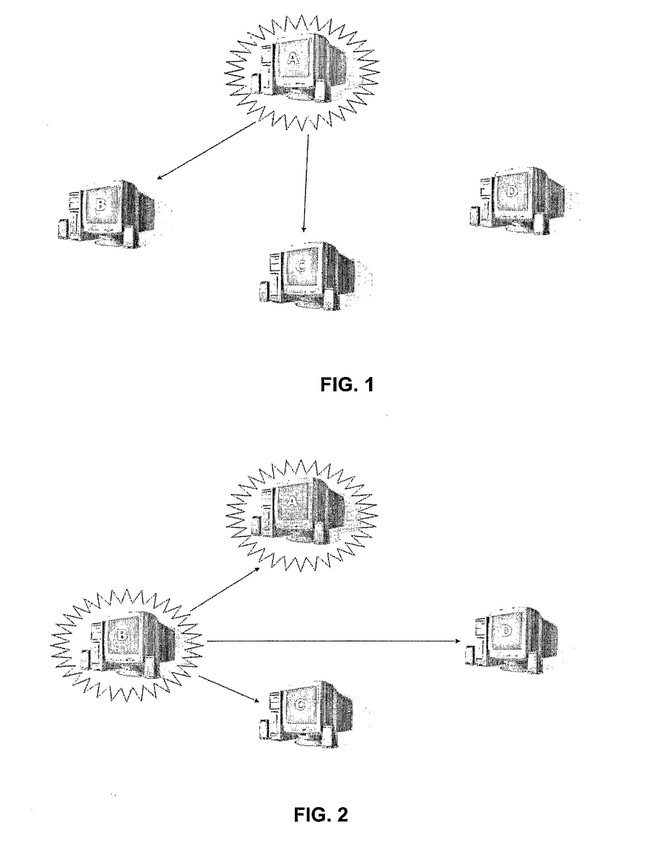

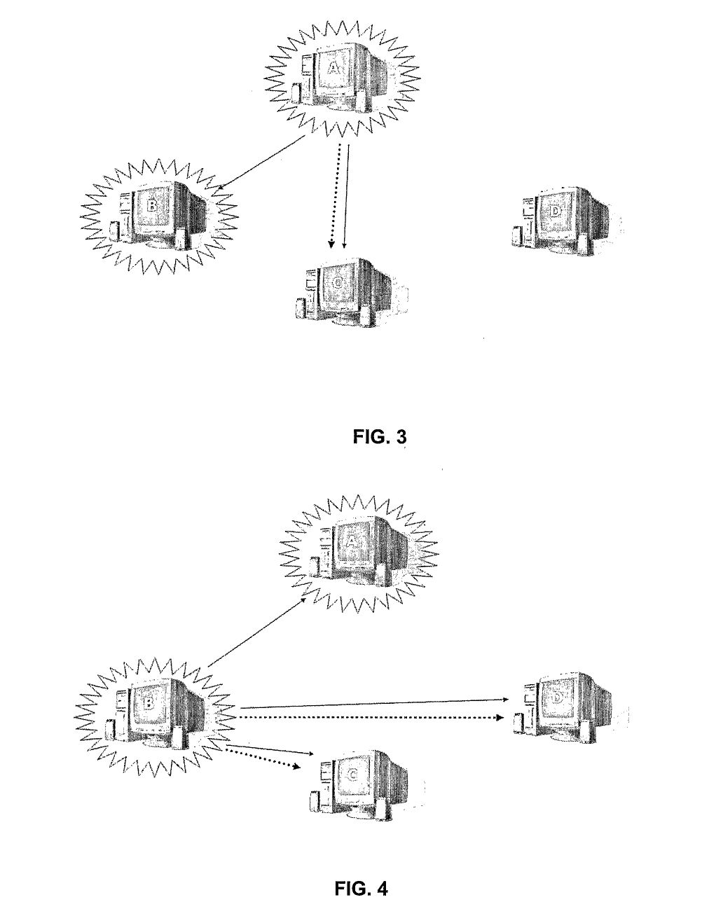

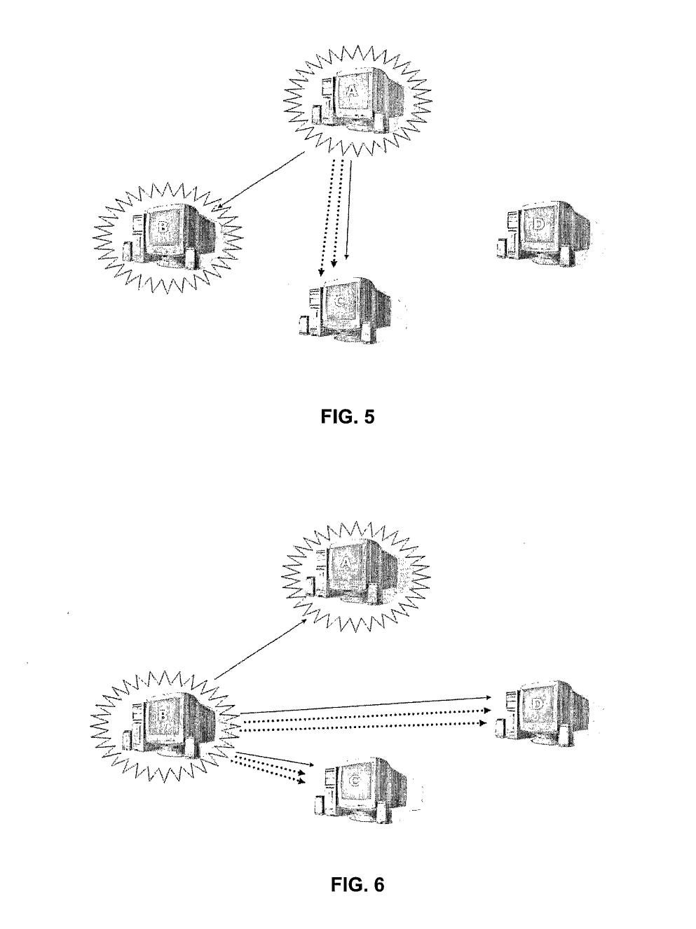

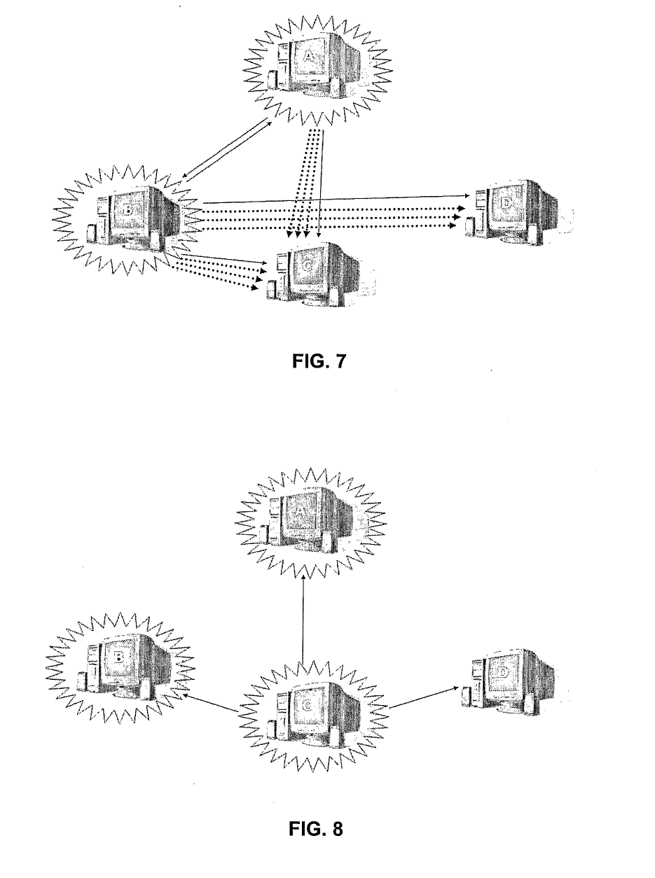

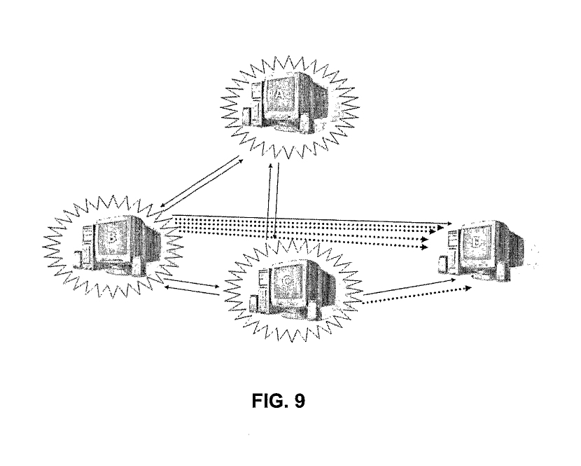

FIGS. 1 to 9 illustrate a possible scenery in which a mail bomber virus spreads into a network of email-using computer systems;

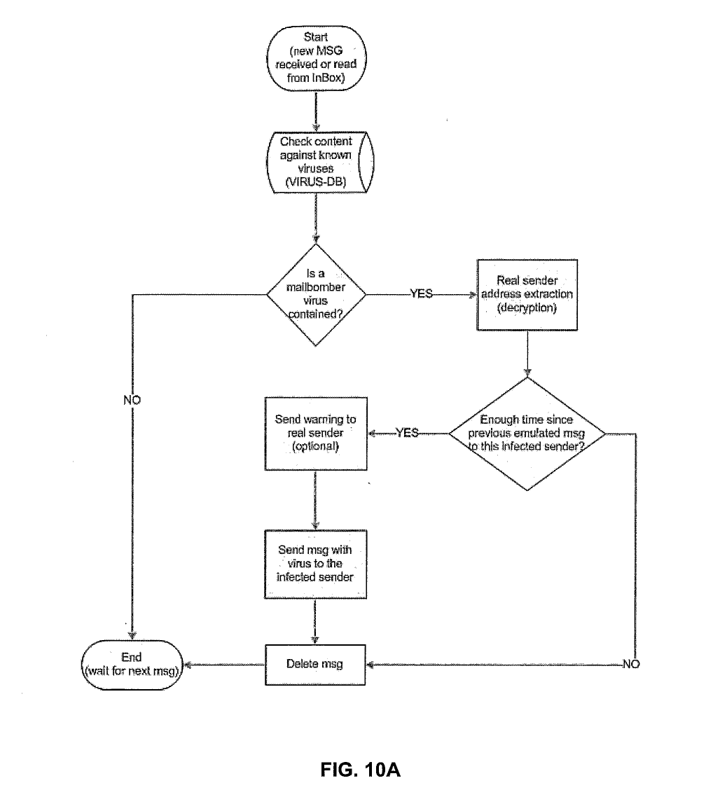

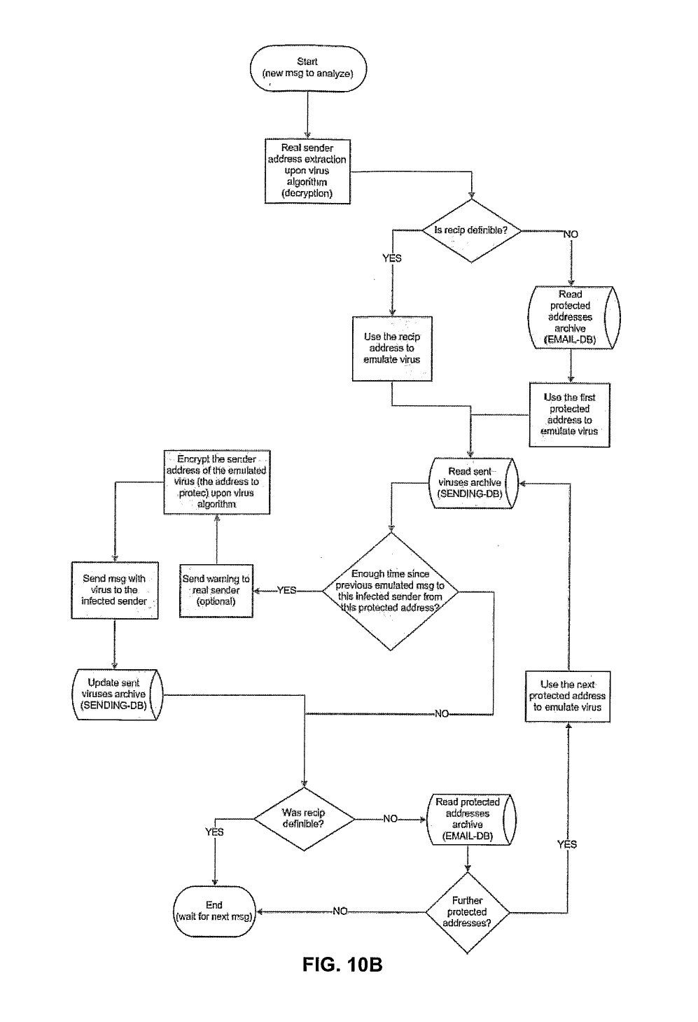

FIGS. 10.A and 10.B are exemplary flow charts of the method according to the present invention: the former sketches a situation in which a generic antivirus program calls the program subject-matter of the present invention and then eliminates the virus-containing message, whereas the latter illustrates in greater detail the sole part regarding the method according to the present invention, which actually relates to the actions to be undertaken in order to emulate a specific virus, regardless of how the infected messages are subsequently treated (they could indifferently be eliminated, displaced, marked or not delivered to the receiver); and

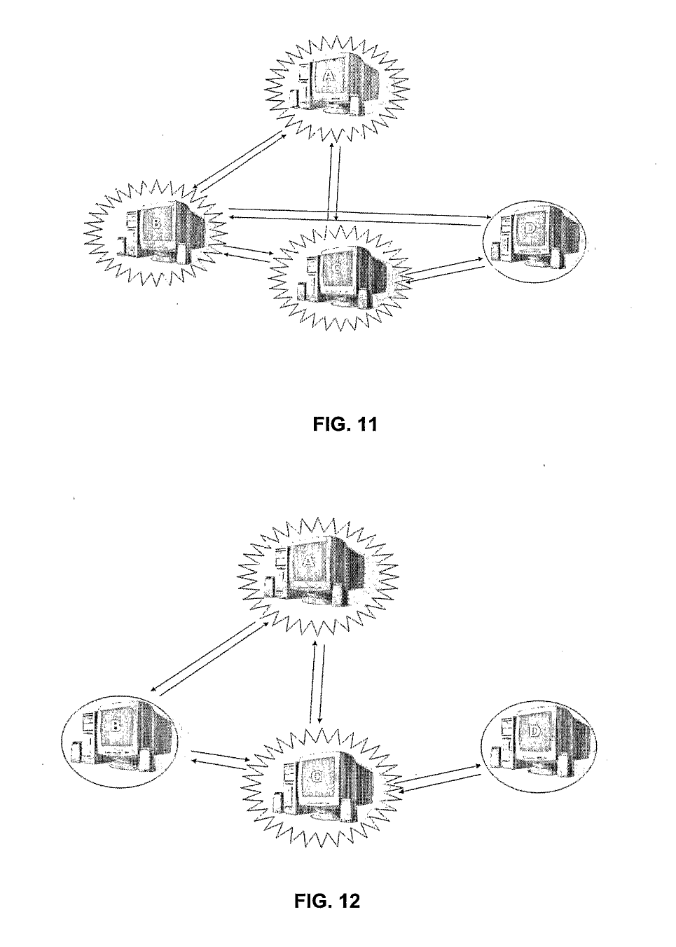

FIGS. 11 and 12 illustrate the effectiveness of the method according to the present invention when used in the scenery of FIGS. 1 to 9.

The virus typology (mail bomber) taken into account in the present invention operates according to a relatively simple mechanism, illustrated hereinafter.

In a computer system network, an infecting system attempts to infect other connected systems, by sending them electronic mail messages that contain the virus itself and, when opened, allow the installing of the virus on the receiving system.

Then, the virus present on the infecting system continues to send wholly random email messages to all those addresses from which it does not periodically receive messages containing the same virus. In practice, it recognizes infected users due to the mere fact that them also send the virus by means of email messages, and these latter users are not bombed with random messages.

If necessary, the virus present on the infecting system will attempt to hide, by encrypting it with an encrypting algorithm different from virus to virus, the email address of the infecting system, from which the messages originate.

Evidently, the spreading of the virus is extremely fast, since each infected system is in turn transformed into an infecting system, whereas the systems left “healthy” are “punished” with an increased bombing of senseless messages, thereby receiving a continuous and increasing incitement to become infected, which is the only way to stop such a bombing.

Hereinafter, with reference to FIGS. 1 to 9, it is illustrated an exemplary situation of how such a virus succeeds to spread.

In particular, an infected system A sends a virus-containing message MV to other two systems, B and C.

Let us suppose that system B becomes infected, whereas system C eliminates the message incoming from A.

Then, the virus, once installed on system B, will send virus-containing messages MV to the email addresses of C and D, e.g. as stored in the address book of the email managing program, and also to the address of system A. This latter address, encrypted in the original message MV, is obtainable only by knowing the type of encryption used by the virus. Therefore, evidently the virus itself, present on system B, could easily extract this information.

The virus present on system A recognizes itself in the message coming from B, decrypts the email address of origin (that of B) and automatically eliminates the message, while systems C and D still have to solve the problem.

Then, system A will again send a virus-containing message MV to the addresses known thereto, hence B and C; moreover it sends a variable number of random messages MC to the systems (C in this exemplary case) that have not yet sent as a response a message containing the virus itself.

Since system B is already infected, the virus present therein recognizes itself in the message coming from A, decrypts the email address of origin (that of A) and automatically eliminates the message.

In turn, system B (infected) will send a virus-containing message MV to all addresses known thereto (in the specific case A, C and D). Moreover, it will send a variable number of random messages MC to the addresses of those systems (C and D) that have not yet responded with related virus-containing messages.

In such a situation, the infected systems (A and B), will continue to bomb the non-infected systems with virus-containing messages MV and with random messages MC, in ever-increasing number.

Such a situation persists, worsening more and more, until another one of the network systems, for instance C, becomes infected.

Then, system C will send a virus-containing message MV to the systems A, B and D.

Systems A and B, being already infected, will automatically eliminate the message coming from C, whereas system D will increasingly be bombed with messages MV and MC from all the other systems.

From the description of the preceding example it would seem that, for a system targeted by such a virus, the only solution to the problem be that of letting itself be infected. In fact, only thus it would be “spared” the continuous bombing with an ever-increasing number of random messages MC coming from all the other infected systems of the network.

Object of the present invention is to solve this problem and protect a system, by tricking the virus into making it believe to have really infected the system itself. In fact, since the response the virus expects is just an email message containing the virus itself, it will suffice that the system to be protected actually sends a copy of the virus itself to a system already infected each time a virus-containing message comes from the latter.

Thus, it is not necessary to know with what frequency the virus would send itself were the user really infected, as such a time table can automatically be adjusted to the messages coming from who is actually infected, thereby simulating an infected state only at the receiving of a virus-generated message.

For instance, if a virus expects to receive at least one message containing itself every 24 hours, then the virus will send itself every 24 hours; therefore, by responding to such a message as soon as it is received, an infected state will automatically be emulated every 24 hours.

Next, FIGS. 10.A and 10.B are exemplary flow charts of the method according to the present invention.

In a network of computer systems interconnected thereamong and apt to swap (send and/or receive) email messages, the only way to know if an incoming message is the “carrier” of a computer virus is to check, through checking means suitable therefor, the presence of the virus in the message itself.

This may be carried out, e.g., by comparing the content of each message incoming in the system to first data stored in a first database VIRUS-DB. In particular, this database specifically contains information suitable for identifying known viruses. Hence, by comparing, according to methodologies per se known, each incoming message to said first database, the presence of a virus, as well as the specific virus type can easily be determined. Of course, there could be singled out and recognized only those viruses with respect to which the first database VIRUS-DB is updated.

Once recognized the specific virus, in case it is a mail bomber virus or the like, the method according to the present invention provides that an emulation program for emulating the virus itself, specific for the particular virus identified, be activated (or called).

This emulation program provides means for extracting from the infected email message an encrypted email address, in particular that related to the message sender, i.e. of the infecting system.

The emulation program is apt to apply the encryption algorithm used by the virus to hide the email address of the sender, to decrypt and then extract said address from the infected message.

Hence, according to the present invention, the antivirus system comprises means for sending, to the email address of the sender (infecting system), an emulation message containing the virus itself therein.

The system that will receive said message (infecting system) expects to find therein both the virus and an email address encrypted according to the same encryption algorithm.

Of course, the emulation program comprises means for encrypting, according to said algorithm, into the message the email address of the system to be protected.

The antivirus system and method subject-matter of the present invention could advantageously be used to concomitantly protect various email addresses; therefore, it could be examining messages intended for different addresses to be protected. This is the case in which the system to be protected concomitantly uses plural email addresses, both as aliases of a same account and as different accounts.

In this case, since the address of the receiver of a message already present on the system could be not determinable, the method according to the present invention provides the option of considering each of the incoming messages as aimed at each of the email addresses to be protected.

In particular, the emulation of the virus, i.e. the step of sending to the sender (infecting system) a message containing the virus and the encrypted address to be protected, is repeated for each of the addresses to be protected. Thus, the virus present on the infecting system will “see” as “infected” all of the addresses to be protected.

Hence, the present invention provides a step of accessing to a second database EMAIL-DB, containing all of the addresses used by the system to be protected and that therefore have to be protected.

From this database it is extracted one of the addresses for which the emulation will have to be carried out.

Prior to sending the virus, the method according to the present invention provides the sending of a warning message that warns the receiver about the fact that a second virus-containing message will follow. This step can be useful in the case in which, at the receiving of the emulated message, the infecting system had already freed itself of the virus at issue, and therefore would risk a new infection via the emulated message containing it.

Of course, concomitantly it is possible to send an invitation to install or update an emulator antivirus according to the present invention.

In order to prevent the onset of endless cycles of emulated responses between two systems using the method according to the present invention, it is advisable to check, before sending a virus-containing message, that such a sending has not already been carried out recently. For this purpose it is kept a database of the sendings SENDING-DB, containing, for each emulated virus, the list of addresses to which it has been sent, the date and the time. Thus, it will be possible to prevent two healthy users that simulate an infected state from continuing to mutually send each other the virus itself. The period of time deemed too short to justify the new sending to the same user may vary on the basis of the specific virus.

Then, upon performing this last check, the emulation program generates a message containing the address to be protected (encrypted with the same encryption algorithm used by the virus) plus the virus itself, setting the address of the originally extracted infecting system as receiver.

Moreover, when a specific virus envisages hiding also the receiver's address, the emulation program should hide the latter according to the same rules.

In order to control recently sent messages, the emulation program files into the sendings database, SENDING-DB, salient data of the message sent, e.g. the virus that has been sent, the receiver's address, the date and the time.

As mentioned above, in case the addresses to be protected were more than one, the method according to the present invention envisages to repeat the preceding points for each of the addresses present in the database of the addresses to be protected, EMAIL-DB, obviously always taking previous sendings into account in order not to trigger an endless cycle between two users using the method according to the present invention.

The virus-containing message will be eliminated (or anyhow treated differently from the other messages) by the antivirus program that has recognized the presence of the virus and activated the emulator program subject-matter of the present invention.

Considering again the exemplary scenery illustrated hereto, with reference to FIGS. 11 and 12 it will presently be described how the use of a method according to the present invention and of an antivirus system adopting said method can sensibly improve the general situation of traffic on a computer system network and of risk due to the uncontrolled spreading of a virus.

In fact, supposing the system D to be equipped with an antivirus program according to the present invention, it may be observed that in its regards there ceases the bombing with random messages MC sent by all of the other infected systems A, B and C.

Moreover, were also other systems, e.g., system B, equipped with an antivirus program according to the present invention, there would be prevented also all the messages exchanged among “protected systems”, reducing even more the traffic and the risk of spreading the virus.

The present invention has hereto been described according to a preferred embodiment thereof, given by way of a non-limiting example.

It is understood that other embodiments could be envisaged, all to be construed as falling within the protective scope thereof, as defined by the appended claims.

1. A method for eliminating a virus of “mail bomber” type or the like from a computer system connected to a computer network and apt to swap email messages by means of one or more email addresses of its own, comprising, for each incoming message sent by a sender, the steps of:
checking the presence of said virus inside said incoming message and, in the affirmative case:
extracting from said incoming message an email address of the related sender; and
sending to said sender address an emulation message containing said virus.

2. The method according to claim 1, wherein said step of checking the presence of the virus inside the incoming message comprises a step of comparing the content of said message to first data stored in a first database (VIRUS-DB), said first data comprising information suitable for identifying viruses already known.

3. The method according to claim 2, comprising a step of identifying a specific virus among those contained in the database (VIRUS-DB) and of activating a specific emulator program.

4. The method according to claim 1, wherein said step of extracting the sender address comprises a step of decrypting said address by using an encrypting/decrypting algorithm specific for the identified virus.

5. The method according to claim 1, wherein said step of sending an emulation message comprises a step of encrypting an address of its own by using an encrypting/decrypting algorithm specific for the identified virus.

6. The method according to claim 1, wherein said step of sending an emulation message is repeated for each of said one or more email addresses of its own.

7. The method according to claim 1, further comprising a step of storing in a database of sendings (SENDING-DB) salient data of the emulation message sent.

8. The method according to claim 7, wherein said data comprises: the type of virus, its own address, the address of the sender of the incoming message, the date and the time.

9. The method according to claim 8, wherein said step of sending an emulation message is conditional to a step of checking the time elapsed from the last sending to the sender address.

10. The method according to claim 9, wherein said step of sending an emulation message is carried out if said elapsed time exceeds a threshold determined on the basis of the specific virus identified.

11. The method according to claim 1, further comprising a step of sending to the sender address a warning message prior to sending the emulation message.

12. An antivirus system for eliminating a virus of “mail bomber” type or the like from a computer system connected to a computer network and apt to swap email messages by means of one or more email addresses of its own, comprising:
means for checking the presence of said virus inside an incoming message;
means for extracting from said incoming message an email address of the sender; and
means for sending to said sender address an emulation message containing said virus.

13. The system according to claim 12, wherein said means for checking the presence of the virus inside the incoming message comprises means for comparing the content of said message to first data stored in a first database (VIRUS-DB), said first data comprising information suitable for identifying viruses already known.

14. The system according to claim 13, comprising means for identifying a specific virus among those contained in the database (VIRUS-DB).

15. The system according to claim 12, wherein said means for extracting the sender address comprises means for decrypting said address by using an encrypting/decrypting algorithm specific for the identified virus.

16. The system according to claim 12, wherein said means for sending an emulation message comprises means for encrypting its own address by using an encrypting/decrypting algorithm specific for the identified virus.

17. The system according to claim 12, wherein said means for sending an emulation message is apt to successively operate for each of said one or more email addresses of its own.

18. The system according to claim 12, further comprising means for storing in a database of sendings (SENDING-DB) salient data of the emulation message sent.

19. The system according to claim 18, wherein said data comprises: the virus type, its own address, the address of the receiver of the incoming message, the date and the time.

20. The system according to claim 19, wherein said means for sending an emulation message operate conditionally to means for checking the time elapsed from the last sending to the sender address.

21. The system according to claim 20, wherein said means for sending an emulation message operate if said elapsed time exceeds a threshold determined on the basis of the specific identified virus.

22. The system according to claim 12, further comprising means for sending to the sender address a warning message prior to sending the emulation message.

23. A computer program product, characterized in that it comprises one or more software programs stored on a storage medium, said computer product being apt to implement a method according to claim 1, when in execution on a computer system.
